(19) United States
(12) Patent Application Publication
(10) Pub. No.: US 2026/0063085 A1
(43) Pub. Date: Mar. 5, 2026

(54) DIAGNOSTIC APPARATUS FOR ENGINE SYSTEM

(71) Applicant: TOYOTA JIDOSHA KABUSHIKI KAISHA, Toyota-shi (JP)

(72) Inventors: Keita FUKUI, Fujinomiya-shi (JP); Hideki MIYAHARA, Miyoshi-shi (JP)

(73) Assignee: TOYOTA JIDOSHA KABUSHIKI KAISHA, Toyota-shi (JP)

(21) Appl. No.: 18/975,261

(22) Filed: Dec. 10, 2024

(30) Foreign Application Priority Data
Mar. 4, 2024 (JP) 2024-032318

(51) Int. Cl. F02D 41/00; F02D 41/22

(52) U.S. Cl. CPC F02D 41/0037; F02D 2041/225

(57) ABSTRACT

A diagnostic apparatus for an engine system includes: a fuel tank including a tank body portion storing fuel and provided with an tank internal pressure sensor, a fuel introduction pipe communicating with the tank body portion, and a check valve for restricting the backflow of fuel from the tank body portion to the fuel introduction pipe; a determination unit for determining whether the tank internal pressure is equal to or higher than an atmospheric pressure in a state in which an engine is stopped and a valve closing command is issued to a sealing valve; a canister leak diagnosis part for performing a leak diagnosis of a canister when an affirmative determination is made in the determination part; and a tank leak diagnostic unit for performing a leak diagnosis of the fuel tank when a determination that there is no leak in the canister.

### CROSS-REFERENCE TO RELATED APPLICATION

This application claims priority to Japanese Patent Application No. 2024-032318 filed on Mar. 4, 2024, incorporated herein by reference in its entirety.

### BACKGROUND

### 1. Technical Field

The disclosure relates to a diagnostic apparatus for an engine system.

### 2. Description of Related Art

When internal pressure of a fuel tank provided in an engine system is no lower than atmospheric pressure, diagnosis may be made that there is no leakage in the fuel tank (e.g., see Japanese Unexamined Patent Application Publication No. 2013-137035 (JP 2013-137035 A)).

### SUMMARY

The fuel tank includes a tank body portion for storing fuel, and a fuel introduction pipe communicating with the tank body portion. Here, it is conceivable to provide a check valve which allows introduction of fuel from the fuel introduction pipe to the tank body portion, but restricts backflow of fuel from the tank body portion to the fuel introduction pipe. In this case, when internal pressure of the tank body portion is no lower than the atmospheric pressure, the check valve may be maintained in a state in which the fuel introduction pipe is closed. In this case, when the internal pressure of the tank body portion is no lower than the atmospheric pressure, the fuel tank may be erroneously diagnosed as having no leak even when there is a leak in the fuel introduction pipe.

Accordingly, an object of the disclosure is to provide a diagnostic apparatus for an engine system, in which accuracy of leak diagnosis of a fuel tank is improved.

A diagnostic apparatus for an engine system according to the above object includes
an engine,
a fuel tank that stores fuel for the engine, the fuel tank including a tank body portion in which the fuel is stored, and in which a tank internal pressure sensor is provided, a fuel introduction pipe communicating with the tank body portion, and a check valve for restricting backflow of the fuel from the tank body portion to the fuel introduction pipe while allowing introduction of the fuel from the fuel introduction pipe into the tank body portion,
a canister that adsorbs fuel vapor generated in the fuel tank,
a vapor passage communicating the fuel tank with the canister,
a purge passage communicating an intake passage of the engine with the canister,
a sealing valve that opens and closes the vapor passage, a purge valve that opens and closes the purge passage,
a canister internal pressure sensor that detects canister internal pressure that is internal pressure of the canister,
a tank internal pressure sensor that detects tank internal pressure that is internal pressure of the fuel tank,
a decompression pump that reduces the canister internal pressure to be lower than atmospheric pressure,
a determination unit that determines whether the tank internal pressure is no lower than the atmospheric pressure in a state in which the engine is stopped and a valve closing command is issued to the sealing valve,
a canister leak diagnostic unit that performs leak diagnosis of the canister when an affirmative determination is made by the determination unit, and
a tank leak diagnostic unit that performs leak diagnosis of the fuel tank, based on at least one of the canister internal pressure and the tank internal pressure after starting operation of the decompression pump in a state in which a valve closing command is issued to the purge valve and a valve opening command is issued to the sealing valve, when diagnosis is made that there is no leak in the canister.

The engine system may include a relief passage connected to the vapor passage by bypassing the sealing valve, and a positive pressure relief valve that opens the relief passage when the tank internal pressure is higher than the canister internal pressure, and differential pressure between the tank internal pressure and the canister internal pressure is no lower than a predetermined valve opening pressure.

The diagnostic apparatus may further include: a stuck-open diagnostic unit that, when an affirmative determination is made by the determination unit, operation of the decompression pump is started in a state in which a valve closing command is issued to the purge valve and the sealing valve, and a reduction amount of the tank internal pressure when reducing the canister internal pressure by a predetermined pressure reduction amount from the atmospheric pressure is no less than a determination value, executes a stuck-open diagnosis that is diagnosis that the sealing valve is stuck open; and a setting unit that sets the determination value to a first value when a pre-start pressure, that is the tank internal pressure before starting operation of the decompression pump, is less than a threshold value obtained by subtracting the pressure reduction amount from the valve opening pressure, and sets the determination value to a second value that increases as the pre-start pressure increases, when the pre-start pressure is no lower than the threshold value.

The canister leak diagnostic unit may execute leak diagnosis regarding the canister based on the canister internal pressure after starting operation of the decompression pump, in a state in which the valve closing command is issued to the purge valve and the sealing valve, and the stuck-open diagnostic unit may execute the stuck-open diagnosis during execution of the leak diagnosis of the canister.

The second value may be a value obtained by adding the first value to a value obtained by subtracting the threshold value from the pre-start pressure.

According to the disclosure, a diagnostic apparatus for an engine system, in which accuracy of leak diagnosis of a fuel tank is improved, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of an engine system;

FIG. 2 is an enlarged view of the periphery of the sealing valve;

FIG. 3 is a flowchart illustrating diagnostic control;

FIG. 4 is a flow chart illustrating stuck-open diagnosis; and

FIG. 5 is a map illustrating a relationship between the pre-start pressure P and the determination value J.

### DETAILED DESCRIPTION OF EMBODIMENTS

### Outline of Engine System

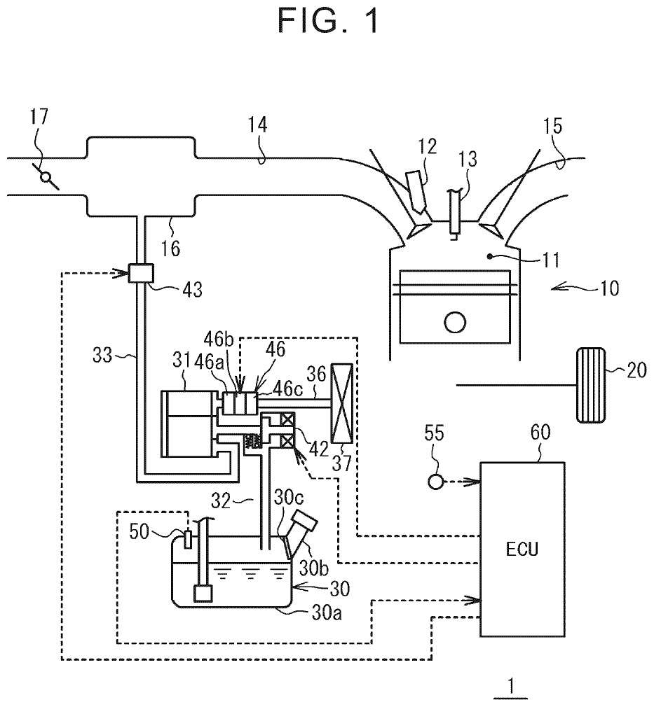

FIG. 1 is a schematic configuration diagram of an engine system 1. In the present embodiment, the engine system 1 is mounted on a vehicle. The engine system 1 includes an engine 10, a fuel tank 30, and an Electronic Control Unit (ECU) 60. The fuel tank 30 stores the fuel of the engine 10. The fuel in the fuel tank 30 is supplied to the fuel injection valve 12 via a fuel supply path. The tank internal pressure sensor 50 detects the pressure in the fuel tank 30.

The power of the engine 10 is transmitted to the drive wheels 20. The engine 10 is provided with a fuel injection valve 12 for injecting and supplying fuel to the combustion chamber 11, and an ignition plug 13 for igniting the air-fuel mixture which is a mixture of the injected fuel and the intake air. An intake passage 14 and an exhaust passage 15 are connected to the combustion chamber 11. A surge fuel tank 16 is provided in the intake passage 14. A throttle valve 17 is provided upstream of the surge fuel tank 16.

The fuel tank 30 includes a tank body portion 30a, a fuel introduction pipe 30b, and a check valve 30c. The tank body portion 30a is configured to store fuel. The fuel introduction pipe 30b guides the fuel to the tank body portion 30a. The check valve 30c permits the introduction of fuel from the fuel introduction pipe 30b to the tank body portion 30a, but regulates the backflow of fuel from the tank body portion 30a to the fuel introduction pipe 30b. As a result, leakage of fuel from the tank body portion 30a to the outside via the fuel introduction pipe 30b is suppressed. The check valve 30c is, for example, a cantilevered on-off valve, but may be a ball check valve.

A canister 31 for adsorbing the fuel vapor generated in the fuel tank 30 is provided. The canister 31 and the fuel tank 30 communicate with each other through a vapor passage 32. The vapor passage 32 is provided with a sealing valve 42 for opening and closing the vapor passage 32. By opening the sealing valve 42, the fuel vapor in the fuel tank 30 is once collected in the adsorbent material of the canister 31.

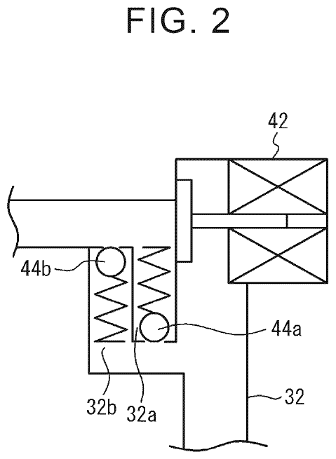

FIG. 2 is an enlarged view of the periphery of the sealing valve 42. Relief passages 32a and 32b bypassing the sealing valve 42 are connected to the vapor passage 32. The relief passages 32a and 32b are provided with a positive pressure relief valve 44a and a negative pressure relief valve 44b, respectively. When the tank internal pressure is higher than the canister internal pressure and the differential pressure between the tank internal pressure and the canister internal pressure is equal to or higher than the predetermined valve opening pressure, the positive pressure relief valve 44a opens the relief passage 32a. When the tank internal pressure is lower than the canister internal pressure and the differential pressure between the tank internal pressure and the canister internal pressure is equal to or higher than the predetermined valve opening pressure, the negative pressure relief valve 44b opens the relief passage 32b. This avoids an excessively high or excessively low tank internal pressure.

The canister 31 and the surge fuel tank 16 communicate with each other through a purge passage 33. The purge passage 33 is provided with a purge valve 43 that opens and closes the purge passage 33. An outside air introduction passage 36 for introducing outside air into the canister 31 is connected to the canister 31. An air filter 37 is provided at an open end of the outside air introduction passage 36.

A module 46 is provided in the outside air introduction passage 36. Module 46 includes a canister internal pressure sensor 46a, a decompression pump 46b, and a switching valve 46c. The canister internal pressure sensor 46a detects the canister internal pressure that is the internal pressure of the canister 31. The decompression pump 46b reduces the canister internal pressure below atmospheric pressure. The switching valve 46c opens and closes the outside air introduction passage 36. During operation of the engine 10, the switching valve 46c opens the outside air introduction passage 36. The decompression pump 46b can reduce the canister internal pressure regardless of whether the switching valve 46c is opened or closed.

When the predetermined condition is satisfied, the purge valve 43 is opened while the switching valve 46c is open and the sealing valve 42 is closed during the operation of the engine 10. As a result, the fuel vapor is removed from the canister 31. The desorbed fuel vapor is introduced into the surge fuel tank 16 via the purge passage 33, and is combusted in the combustion chamber 11.

ECU 60 is an electronic control unit including an arithmetic processing unit that performs various arithmetic processing related to travel control of vehicles, and a memory that stores control programs and data. ECU 60 is connected with various sensors for detecting the operating condition of the engine 10, the canister internal pressure sensor 46a, the tank internal pressure sensor 50, the ignition switch 55, and the like. ECU 60 executes various controls of the vehicles and the engine 10 based on the sensors and the signals from the switches. ECU 60 issues a valve opening command or a valve closing command to each of the sealing valve 42, the purge valve 43, and the switching valve 46c. Although ECU 60 will be described in detail later, it is an exemplary diagnostic apparatus of the engine system 1. ECU 60 functionally realizes a determination unit, a canister leak diagnostic unit, a tank leak diagnostic unit, a stuck-open diagnostic unit, and a setting unit.

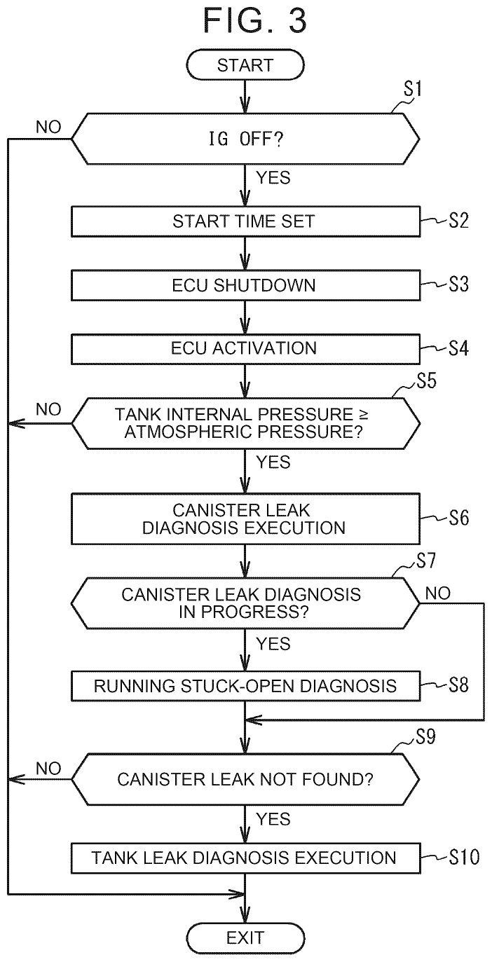

Diagnostic Control FIG. 3 is a flowchart illustrating diagnostic control. ECU 60 determines whether the ignition-off has been detected (S1). If S1 is No, this control ends. If S1 is Yes, ECU 60 sets the next ECU 60 startup time (S2). ECU 60 then ceases (S3). The start time of ECU 60 is, for example, a time at which a certain period of time has elapsed since immediately before ECU 60 is stopped. The predetermined time period is, for example, one hour. When the present time reaches the start time, ECU 60 automatically starts (S4).

Next, ECU 60 determines whether the tank internal pressure is equal to or higher than the atmospheric pressure (S5). Here, the atmospheric pressure varies depending on weather and altitude. For this reason, the atmospheric pressure here does not mean 0 kPa at gage pressure, and for example, −0.2 kPa to +0.2 kPa is set to atmospheric pressure in view of a predetermined variation range. Therefore, for example, when the tank internal pressure is equal to or higher than −0.2 kPa, the tank internal pressure is determined to be equal to or higher than the atmospheric pressure. S5 is an exemplary process executed by the determination unit. If S5 is No, this control ends.

### Canister Leak Diagnosis

If S5 is Yes, ECU 60 performs canister leak diagnostics (S6). In the canister leak diagnosis, ECU 60 issues a valve closing command to the sealing valve 42 and the purge valve 43, and diagnoses the presence or absence of a leak in the canister 31 based on the canister internal pressure after the operation of the decompression pump 46b is started. When the canister internal pressure is maintained at atmospheric pressure, ECU 60 diagnoses that there is a leak in the canister 31. When the canister internal pressure becomes a negative pressure lower than the atmospheric pressure, ECU 60 diagnoses that the canister 31 does not leak. S6 is an exemplary process executed by the canister leak diagnostic unit.

Next, ECU 60 determines whether the canister leak diagnosis is being performed (S7). If S7 is Yes, ECU 60 performs a stuck-open diagnosis (S8). That is, the stuck-open diagnosis is executed during the execution of the canister leak diagnosis. In the stuck-open diagnosis, the stuck-open diagnosis of the sealing valve 42 is performed based on the tank internal pressure after the operation of the decompression pump 46b in the canister leak diagnosis described above is started. stuck open means that the sealing valve 42 is fixed in an open state. In this way, the stuck-open diagnosis is executed during the execution of the canister leak diagnosis. Therefore, both diagnoses are performed in a short time. The stuck-open diagnosis will be described in detail later.

Next, ECU 60 determines whether there is no leak in the canister 31 based on the diagnosis result of the canister leak diagnosis (S9). If S9 is No, that is, if it is diagnosed that there is a leak in the canister 31, this control is ended. If No in S7, S9 is executed.

### Tank Leak Diagnosis

If S9 is Yes, ECU 60 performs tank leak diagnostics (S10). The tank leak diagnosis is performed as follows. ECU 60 issues a valve opening instruction to the purge valve 43, and returns the canister internal pressure reduced by the canister leak diagnosis to the atmospheric pressure. Next, ECU 60 issues a valve closing command to the purge valve 43, issues a valve opening command to the sealing valve 42, and causes the canister 31 and the fuel tank 30 to communicate with each other. ECU 60 then initiates operation of the decompression pump 46b. As a result, the inside of the canister 31 and the inside of the fuel tank 30 are depressurized. ECU 60 diagnoses leakage of the fuel tank 30 based on at least one of the canister internal pressure and the tank internal pressure after starting the operation of the decompression pump 46b. When the amount of decrease in at least one of the canister internal pressure and the tank internal pressure is equal to or greater than the determination value from the beginning of the operation of the decompression pump 46b, it is diagnosed that there is no leakage in the fuel tank 30. Even if the operation of the decompression pump 46b is started, it is diagnosed that there is a leak in the fuel tank 30 when the amount of decrease in at least one of the canister internal pressure and the tank internal pressure is less than the determination value. S10 is an exemplary process executed by the tank leakage diagnostic unit.

As described above, the tank leak diagnosis is executed in a state in which the valve closing command is issued to the purge valve 43 and the valve opening command is issued to the sealing valve 42 when the tank internal pressure is equal to or higher than the atmospheric pressure. Therefore, even when the tank internal pressure is positive and the check valve 30c closes the fuel introduction pipe 30b, the check valve 30c opens the fuel introduction pipe 30b by reducing the pressure in the tank body portion 30a. As a result, a leak diagnosis of the fuel tank 30 including the fuel introduction pipe 30b is performed. As described above, the accuracy of the leak diagnosis of the fuel tank 30 is improved.

### Stuck-Open Diagnosis

Next, the stuck-open diagnosis will be described. In the stuck-open diagnosis, the operation of the decompression pump 46b is started in the above-described canister leak diagnosis, and the canister internal pressure is reduced by a predetermined pressure reduction amount B from the atmospheric pressure based on the decrease amount C of the tank internal pressure. When the decrease amount C of the tank internal pressure is equal to or greater than the determination value J, it is diagnosed that the sealing valve 42 is stuck open. When the decrease amount C of the tank internal pressure is less than the determination value J, it is diagnosed that the sealing valve 42 is not stuck open.

As shown in FIG. 2, a positive pressure relief valve 44a is provided in the relief passage 32a bypassing the sealing valve 42. When the tank internal pressure is higher than the canister internal pressure and the differential pressure between the tank internal pressure and the canister internal pressure becomes equal to or higher than the predetermined valve opening pressure A, the positive pressure relief valve 44a opens. When the sealing valve 42 is not stuck open, the canister internal pressure decreases due to the start of the operation of the decompression pump 46b, and the differential pressure between the canister internal pressure and the tank internal pressure increases. When the differential pressure is equal to or higher than the valve opening pressure A, the positive pressure relief valve 44a opens and the tank internal pressure decreases. At this time, when the decrease amount C of the tank internal pressure becomes equal to or larger than the determination value J, there is a possibility that the sealing valve 42 is erroneously diagnosed as being stuck open even though the sealing valve 42 is closed. Therefore, ECU 60 sets the determination value J as follows.

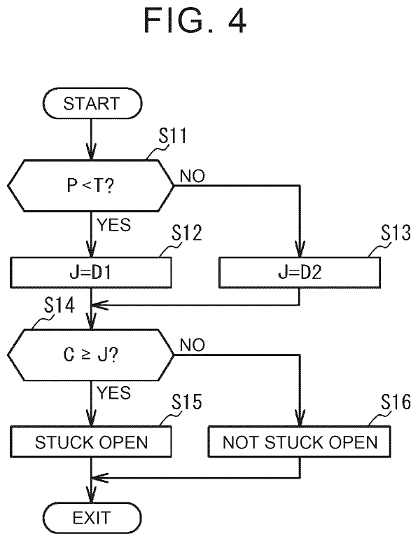

FIG. 4 is an exemplary flowchart illustrating an stuck-open diagnosis. ECU 60 determines whether the pre-start pressure P is less than a threshold T (S11). The pre-start pressure P is the tank internal pressure prior to the start of operation of the decompression pump 46b. The tank internal pressure used in the determination of S5 may be used as the pre-start pressure P. If S11 is Yes, ECU 60 sets the determination value J to the first value D1 (S12). If S11 is No, ECU 60 sets the determination value J to the second value D2 (S13). Next, it is determined whether the decrease amount C is equal to or greater than the determination value J (S14). If S14 is Yes, ECU 60 diagnoses that the sealing valve 42 is stuck open S15. If S14 is No, ECU 60 will S16 that the sealing valve 42 is not stuck open.

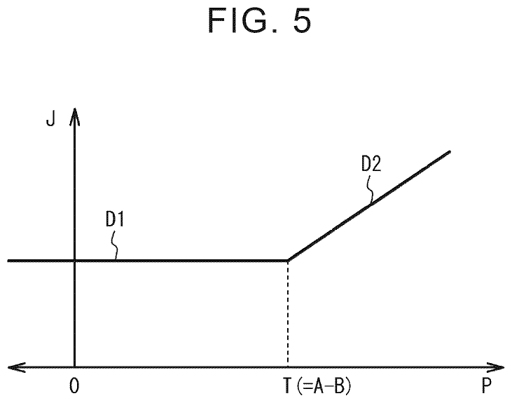

FIG. 5 is a map illustrating a relationship between the pre-start pressure P and the determination value J. When the pre-start pressure P is less than the threshold T, the positive pressure relief valve 44a does not open due to a decrease in the canister internal pressure caused by the decompression pump 46b. When the pre-start pressure P is equal to or higher than the threshold T, the positive pressure relief valve 44a opens due to a decrease in the canister internal pressure caused by the decompression pump 46b. The threshold T is set to a value obtained by subtracting the pressure reduction amount B from the valve opening pressure A. For example, when the valve opening pressure A is 20 kPa and the pressure reduction amount B is 5 kPa, the threshold T is 15 kPa. When the pre-start pressure P is less than 15 kPa, the positive pressure relief valve 44a is not opened even when the decompression pump 46b is operated. This is because even if the canister internal pressure 5 kPa decreases from the atmospheric pressure, the difference between the canister internal pressure and the tank internal pressure is less than 20 kPa. When the pre-start pressure P is equal to or higher than 15 kPa, the positive pressure relief valve 44a is opened by the operation of the decompression pump 46b. This is because when the canister internal pressure 5 kPa decreases from the atmospheric pressure, the differential pressure becomes equal to or higher than 20 kPa during the decrease of the canister internal pressure.

When the canister internal pressure becomes −5 kPa after the positive pressure relief valve 44a is opened by the operation of the decompression pump 46b, the positive pressure relief valve 44a is closed when the tank internal pressure becomes less than 15 kPa. For example, when the pre-start pressure P is 17 kPa, when the canister internal pressure drops to −3 kPa, the positive pressure relief valve 44a opens, and after the canister internal pressure becomes −5 kPa, the canister internal pressure drops to less than 15 kPa and the positive pressure relief valve 44a closes. When the pre-start pressure P is 19 kPa, when the canister internal pressure drops to −1 kPa, the positive pressure relief valve 44a opens, and after the canister internal pressure becomes −5 kPa, the canister internal pressure drops to less than 15 kPa and the positive pressure relief valve 44a closes. In this way, the tank internal pressure is constant when the positive pressure relief valve 44a is closed regardless of the pre-start pressure P. In other words, the higher the pre-start pressure P, the higher the decrease amount C of the tank internal pressure due to the opening of the positive pressure relief valve 44a.

As shown in FIG. 5, the first value D1 is a constant value regardless of the tank internal pressure. This is because if the pre-start pressure P is less than the threshold T, the positive pressure relief valve 44a is not opened by the operation of the decompression pump 46b. The second value D2 is a value equal to or larger than the first value D1, and increases as the tank internal pressure increases. As described above, when the pre-start pressure P is equal to or higher than the threshold T, the decrease amount C due to the opening of the positive pressure relief valve 44a increases as the pre-start pressure P increases. Therefore, in order to avoid the decrease amount C being equal to or greater than the determination value J due to the opening of the positive pressure relief valve 44a, the second value D2 becomes higher as the pre-start pressure P is higher.

The first value D1 is smaller than the pressure reduction amount B. This is because, in a case where the sealing valve 42 is slightly opened and fixed, there is a possibility that the tank internal pressure is reduced with respect to the reduction of the canister internal pressure. For example, the first value D1 is 4 kPa. When the pre-start pressure P is equal to or higher than the threshold T, the pre-start pressure P and the decrease amount C due to the opening of the positive pressure relief valve 44a are directly proportional to each other. Therefore, the second value D2 may be a value obtained by adding a value obtained by subtracting the threshold T from the pre-start pressure P to the first value D1.

Although the embodiments of the disclosure have been described in detail above, the disclosure is not limited to such specific embodiments, and various modifications and changes can be made within the scope of the gist of the disclosure described in the claims.

What is claimed is:

1. A diagnostic apparatus for an engine system, the diagnostic apparatus comprising:
an engine;
a fuel tank that stores fuel for the engine, the fuel tank including a tank body portion in which the fuel is stored, and in which a tank internal pressure sensor is provided, a fuel introduction pipe communicating with the tank body portion, and a check valve for restricting backflow of the fuel from the tank body portion to the fuel introduction pipe while allowing introduction of the fuel from the fuel introduction pipe into the tank body portion;
a canister that adsorbs fuel vapor generated in the fuel tank;
a vapor passage communicating the fuel tank with the canister;
a purge passage communicating an intake passage of the engine with the canister;
a sealing valve that opens and closes the vapor passage; a purge valve that opens and closes the purge passage;
a canister internal pressure sensor that detects canister internal pressure that is internal pressure of the canister;
a tank internal pressure sensor that detects tank internal pressure that is internal pressure of the fuel tank;
a decompression pump that reduces the canister internal pressure to be lower than atmospheric pressure;
a determination unit that determines whether the tank internal pressure is no lower than the atmospheric pressure in a state in which the engine is stopped and a valve closing command is issued to the sealing valve;
a canister leak diagnostic unit that performs leak diagnosis of the canister when an affirmative determination is made by the determination unit; and
a tank leak diagnostic unit that performs leak diagnosis of the fuel tank, based on at least one of the canister internal pressure and the tank internal pressure after starting operation of the decompression pump in a state in which a valve closing command is issued to the purge valve and a valve opening command is issued to the sealing valve, when diagnosis is made that there is no leak in the canister.

2. The diagnostic apparatus according to claim 1, wherein:
the engine system includes a relief passage connected to the vapor passage by bypassing the sealing valve, and a positive pressure relief valve that opens the relief passage when the tank internal pressure is higher than the canister internal pressure, and differential pressure between the tank internal pressure and the canister internal pressure is no lower than a predetermined valve opening pressure; and
the diagnostic apparatus includes
a stuck-open diagnostic unit that, when an affirmative determination is made by the determination unit, operation of the decompression pump is started in a state in which a valve closing command is issued to the purge valve and the sealing valve, and a reduction amount of the tank internal pressure when reducing the canister internal pressure by a predetermined pressure reduction amount from the atmospheric pressure is no less than a determination value, executes a stuck-open diagnosis that is diagnosis that the sealing valve is stuck open, and
a setting unit that sets the determination value to a first value when a pre-start pressure, that is the tank internal pressure before starting operation of the decompression pump, is less than a threshold value obtained by subtracting the pressure reduction amount from the valve opening pressure, and sets the determination value to a second value that increases as the pre-start pressure increases, when the pre-start pressure is no lower than the threshold value.

3. The diagnostic apparatus according to claim 2, wherein:
the canister leak diagnostic unit executes leak diagnosis regarding the canister based on the canister internal pressure after starting operation of the decompression pump, in a state in which the valve closing command is issued to the purge valve and the sealing valve; and
the stuck-open diagnostic unit executes the stuck-open diagnosis during execution of the leak diagnosis of the canister.

4. The diagnostic apparatus according to claim 2, wherein the second value is a value obtained by adding the first value to a value obtained by subtracting the threshold value from the pre-start pressure.
